(19) United States
(12) Patent Application Publication
(10) Pub. No.: US 2016/0364260 A1
(43) Pub. Date: Dec. 15, 2016

(54) EVENT ROUTER AND ROUTING METHOD FOR SYMMETRIC MULTIPROCESSOR VIRTUAL MACHINE USING QUEUE

(71) Applicant: Electronics and Telecommunications Research Institute, Daejeon (KR)

(72) Inventor: Jung-Sub SHIN, Gyeonggi-do (KR)

(21) Appl. No.: 15/172,557

(22) Filed: Jun. 3, 2016

(30) Foreign Application Priority Data
Jun. 9, 2015 (KR) 10-2015-0081125

(51) Int. Cl. G06F 9/455; G06F 9/54

(52) U.S. Cl. CPC G06F 9/45558; G06F 9/542

(57) ABSTRACT

Disclosed herein are an event router and an event routing method for a virtual machine using a queue. The event router includes an event delivery decision unit for deciding on a method of delivering an event that is provided to a hypervisor, based on state information of virtual Central Processing Units (vCPUs) used by a Symmetric Multiprocessor (SMP) virtual machine, and an event delivery unit for delivering the event to a relevant virtual CPU based on both the event delivery method and the state information.

### CROSS REFERENCE TO RELATED APPLICATION

This application claims the benefit of Korean Patent Application No. 10-2015-0081125, filed Jun. 9, 2015, which is hereby incorporated by reference in its entirety into this application.

### BACKGROUND OF THE INVENTION

1. Technical Field

The present invention generally relates to technology for routing the event of a Symmetric Multiprocessor (SMP) virtual machine and, more particularly, to event routing technology that may be applied to a hypervisor for managing and running virtual machines so as to minimize the delay of event processing.

2. Description of the Related Art

A Symmetric Multiprocessor (SMP) (or symmetric multiprocessing system) is a system in which multiple Central Processing Units (CPUs) having the same performance are used in a single shared memory space. An SMP is a system designed to overcome the limitations in the performance of a Uni-processor (UP) system, which uses a single CPU.

Such an SMP has been used even in virtualization environments. A hypervisor, such as Xen, a Kernel-based Virtual Machine (KVM), or VMware, functions to generate virtual CPUs (vCPUs) regardless of the number of physical CPUs (pCPUs) and to freely provide vCPUs to multiple virtual machines. In particular, a hypervisor may run multiple vCPUs by scheduling pCPUs. An SMP virtual machine denotes a virtual machine that uses multiple vCPUs provided by the hypervisor.

Since an existing SMP is configured such that multiple CPUs are operated in a single system, there are more problems that must be taken into consideration than in the case of a Uni-processor (UP). One of the problems is determining to which of the CPUs belonging to the SMP an event is to be delivered. The reason for this is that each of most events only needs to be delivered to any one of the CPUs of the SMP. An SMP physical machine that uses pCPUs may immediately process an event regardless of which pCPU the event is forwarded to. The reason for this is that each pCPU is always in an operating state.

However, an SMP virtual machine that uses vCPUs differs from the SMP physical machine. Each vCPU repeatedly enters an operating state and a stopped state depending on the scheduler of the hypervisor. When an event is delivered to a vCPU in an operating state, it may be immediately processed, whereas when an event is delivered to a vCPU in a stopped state, an event processing delay occurs, due to which the event cannot be processed until the vCPU enters an operating state. Such an event processing delay greatly influences Input/Output (I/O) performance.

A hypervisor provides a virtual machine with a virtual environment that is identical to a physical environment. Therefore, the hypervisor delivers an event to a vCPU set by an SMP virtual machine. However, this scheme is very inefficient from the standpoint of the above-described problem. The reason for this is that the SMP virtual machine cannot recognize the operating or stopped state of the vCPU, and always assumes that the vCPU is an operating pCPU. The state of each vCPU may be recognized only by the hypervisor.

Korean Patent Application Publication No. 10-2012-0063436 discloses technology in which loads are distributed to multiple CPUs of an SMP physical machine so that the SMP physical machine is efficiently utilized.

However, Korean Patent Application Publication No. 10-2012-0063436 merely discloses technology for distributing loads to CPUs that are always in an operating state, and cannot be applied to a vCPU that repeatedly enters a stopped state and an operating state.

Therefore, from the standpoint of the current trend, in which multiple virtual machines are installed and used in a single computer, there is a need for technology capable of minimizing an event processing delay occurring in the virtual machine.

### SUMMARY OF THE INVENTION

Accordingly, the present invention has been made keeping in mind the above problems occurring in the prior art, and an object of the present invention is to reduce the time consumed by event processing delay using operating state information provided by a hypervisor.

In accordance with an aspect of the present invention to accomplish the above object, there is provided an event router for a virtual machine, including an event delivery decision unit for deciding on a method of delivering an event that is provided to a hypervisor, based on state information of virtual Central Processing Units (vCPUs) used by a Symmetric Multiprocessor (SMP) virtual machine; and an event delivery unit for delivering the event to a relevant virtual CPU based on both the event delivery method and the state information.

The event delivery method may include a method of immediately delivering the event to the relevant virtual CPU and a method of temporarily storing the event in a storage unit.

The state information of the virtual CPUs may include information about whether each of the virtual CPUs is in an operating state.

The event delivery decision unit may include an operation/non-operation determination unit for determining, based on the state information, whether at least one of the virtual CPUs is in an operating state.

The event delivery decision unit may be configured to, when it is determined that there is a virtual CPU in an operating state, transmit the event to the event delivery unit.

The event delivery decision unit may be configured to, when it is determined that all of the virtual CPUs are in a stopped state, temporarily store the event in the storage unit.

The event delivery unit may include a determination unit for determining a virtual CPU that operates first, based on the state information; and a forwarding unit for forwarding the event temporarily stored in the storage unit to the virtual CPU determined by the determination unit.

The forwarding unit may forward the event before the virtual CPU is operated.

The storage unit may temporarily store the event in a queue.

The forwarding unit may forward the event to the virtual CPU in a First In First Out (FIFO) manner.

In accordance with another aspect of the present invention to accomplish the above object, there is provided an event routing method for a virtual machine, including deciding on a method of delivering an event that is provided to a hypervisor, based on state information of virtual Central Processing Units (vCPUs) used by a Symmetric Multiprocessor (SMP) virtual machine; and delivering the event to a relevant virtual CPU based on both the event delivery method and the state information.

The event delivery method may include a method of immediately delivering the event to the relevant virtual CPU and a method of temporarily storing the event in a storage unit.

The state information of the virtual CPUs may include information about whether each of the virtual CPUs is in an operating state.

Deciding on the event delivery method may include determining, based on the state information, whether at least one of the virtual CPUs is in an operating state.

Deciding on the event delivery method may be configured to, when it is determined that there is a virtual CPU in an operating state, decide on a method of delivering the event to the relevant virtual CPU as the event delivery method.

Deciding on the event delivery method may be configured to, when it is determined that all of the virtual CPUs are in a stopped state, decide on a method of temporarily storing the event in the storage unit as the event delivery method.

Delivering the event to the relevant virtual CPU may include determining a virtual CPU that operates first, based on the state information; and forwarding the event temporarily stored in the storage unit to the virtual CPU that operates first.

Forwarding the event to the virtual CPU may be configured to forward the event before the virtual CPU is operated.

The storage unit may temporarily store the event in a queue.

Forwarding the event to the virtual CPU may be configured to forward the event to the virtual CPU in a First In First Out (FIFO) manner.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing an event router for an SMP virtual machine using a queue according to an embodiment of the present invention;

FIG. 2 is a block diagram showing an embodiment of the event delivery unit shown in FIG. 1;

FIG. 3 is a diagram showing a hypervisor in which the event router for an SMP virtual machine using a queue is used according to an embodiment of the present invention;

FIG. 4 is a diagram showing event routing when a virtual CPU (vCPU) in an operating state is present in the event router for an SMP virtual machine using a queue according to an embodiment of the present invention;

FIGS. 5 and 6 are diagrams showing event routing when a virtual CPU in an operating state is not present in the event router for an SMP virtual machine using a queue according to an embodiment of the present invention;

FIG. 7 is an operation flowchart showing an event routing method for an SMP virtual machine using a queue according to an embodiment of the present invention;

FIG. 8 is an operation flowchart showing in detail the step of deciding on an event delivery method, shown in FIG. 7; and

FIG. 9 is an operation flowchart showing in detail the step of delivering an event to a virtual CPU, shown in FIG. 7.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

First, the terms used in the present specification will be defined as follows.

The term “event” denotes not all events, but only an event that causes no problem even if it is delivered to any one of the virtual CPUs (vCPUs) in SMP virtual machine that receives the event. For example, such an event may refer to all signals causing interrupts in the vCPUs, such as an Interrupt Request (IRQ) from an external device or a signal used to perform communication between virtual machines provided by a hypervisor. That is, such signals are examples of events that are pertinent to the present specification. Here, an event that must be delivered to a specific vCPU among vCPUs provided by the hypervisor is not an event that is pertinent to the present specification.

The term “event routing” denotes the procedure for dynamically selecting the vCPU that will receive an event depending on the states of the vCPUs of the SMP virtual machine that will process the event at the time at which the event occurs, and for forwarding the event to the selected vCPU.

Hereinafter, preferred embodiments of the present invention will be described in detail with reference to the attached drawings.

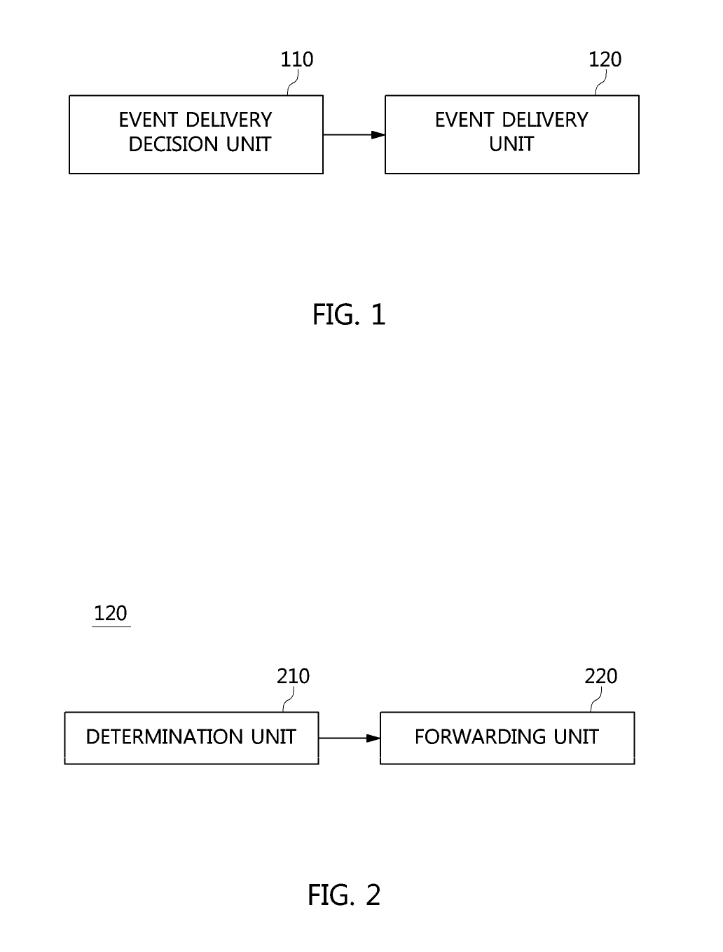

FIG. 1 is a block diagram showing an event router for an SMP virtual machine using a queue according to an embodiment of the present invention.

Referring to FIG. 1, the event router for an SMP virtual machine using a queue according to the embodiment of the present invention includes an event delivery decision unit 110 and an event delivery unit 120.

The event delivery decision unit 110 decides on the method of delivering the event that is provided to a hypervisor, based on the information about the states of virtual CPUs (vCPUs) used by an SMP virtual machine.

The SMP virtual machine denotes a virtual machine which uses multiple vCPUs generated by the hypervisor, wherein respective vCPUs may independently process tasks.

The vCPUs are virtual CPUs generated by the hypervisor and may be driven by scheduling physical CPUs (pCPUs).

The state information of the vCPUs may include pieces of information about whether respective virtual CPUs are operating. For example, if it is assumed that there are four vCPUs that are used by the virtual machine, that is, vCPU 1, vCPU 2, vCPU 3, and vCPU 4, information indicating that all of vCPU 1 to vCPU 4 are operating may be the state information of the virtual CPUs. The state information of the virtual CPUs may be stored in a storage unit. When there are multiple virtual machines, the state information of virtual CPUs that are used by each virtual machine may be stored in the storage unit.

Here, the methods of delivering events may chiefly include two methods: one is the method of immediately delivering an event to a vCPU and the other is the method of temporarily storing an event without immediately delivering the event to a vCPU and of subsequently delivering the event to the vCPU. When the vCPU is in an operating state, it is faster to immediately deliver the event to the vCPU. However, the hypervisor cannot predict which vCPU will first enter an operating state. Therefore, when there is no vCPU that is in an operating state, it is preferable to temporarily store the event without immediately delivering the event, determine the vCPU that operates first, and then deliver the event to the determined vCPU, in order to reduce the latency time.

In this case, the event delivery decision unit 110 may include an operation/non-operation determination unit (not shown) for determining, based on the state information of the vCPUs, whether at least one of the virtual CPUs is in an operating state.

The event delivery decision unit 110 may decide on an event delivery method based on the results of determination by the operation/non-operation determination unit. For example, if it is determined that there is any vCPU in an operating state, the event delivery decision unit 110 immediately transmits the event to the event delivery unit 120, and the event delivery unit 120 may deliver the event to the vCPU. In contrast, if it is determined that there is no vCPU in an operating state, the event delivery decision unit 110 may transmit the event to a storage unit (not shown) so as to store the event in the storage unit, without immediately transmitting the event to the event delivery unit 120.

Here, the storage unit may refer to memory used by the hypervisor. That is, the hypervisor may operate space, in which the state information and events of vCPUs are stored for each virtual machine, in the memory used by the hypervisor.

In this case, the storage unit may temporarily store events using queues. The number of queues may be the same as the number of virtual machines. For example, when four virtual machines generated by the hypervisor are present, the number of queues may also be four.

The events stored in the storage unit may be delivered to the corresponding vCPUs in a First In First Out (FIFO) manner.

The FIFO manner may denote a scheme in which the oldest (first) event is processed first (earlier than the last event).

The event delivery unit 120 delivers the corresponding event to the vCPU based on the event delivery method and the state information.

When it is determined by the event delivery decision unit 110 that there is any vCPU in an operating state and the event is transmitted to the event delivery unit 120, the event delivery unit 120 may receive the event and deliver it to the vCPU.

Further, when it is determined by the event delivery decision unit 110 that all vCPUs are in a stopped state and the event is transmitted to the storage unit, the event delivery unit 120 may receive the event from the storage unit and deliver it to the corresponding vCPU.

In this case, the vCPU that operates first is determined based on the state information, and the event temporarily stored in the storage unit may be delivered to the vCPU that starts operating first. For example, when all of the virtual CPUs vCPU 1 to vCPU 4 are determined to be in a stopped state and the event is temporarily stored in the storage unit, the event may be delivered to vCPU 2, which first enters an operating state in a scheduling procedure. The event temporarily stored in the storage unit may be immediately delivered to vCPU 2 when state information indicating the initiation of the operation of vCPU 2 is received after vCPU 2 has started to operate. That is, the event may be transmitted immediately after vCPU 2 has started to operate, and may then be processed, thus minimizing the delay in event processing of the virtual machine.

Here, the event stored in the storage unit may also be delivered to the corresponding vCPU before the vCPU is operated. For example, the event may be delivered before vCPU 2 is operated in the case where all of the virtual CPUs vCPU 1 to vCPU 4 are determined to be in a stopped state and the event is temporarily stored in the storage unit, and where the scheduler in the hypervisor designates the virtual CPU that operates first as vCPU 2 and the event temporarily stored in the storage unit must be delivered to vCPU 2. That is, the delay in the event processing by the virtual machine may be minimized by enabling the event to be processed at the same time that vCPU 2 is operated.

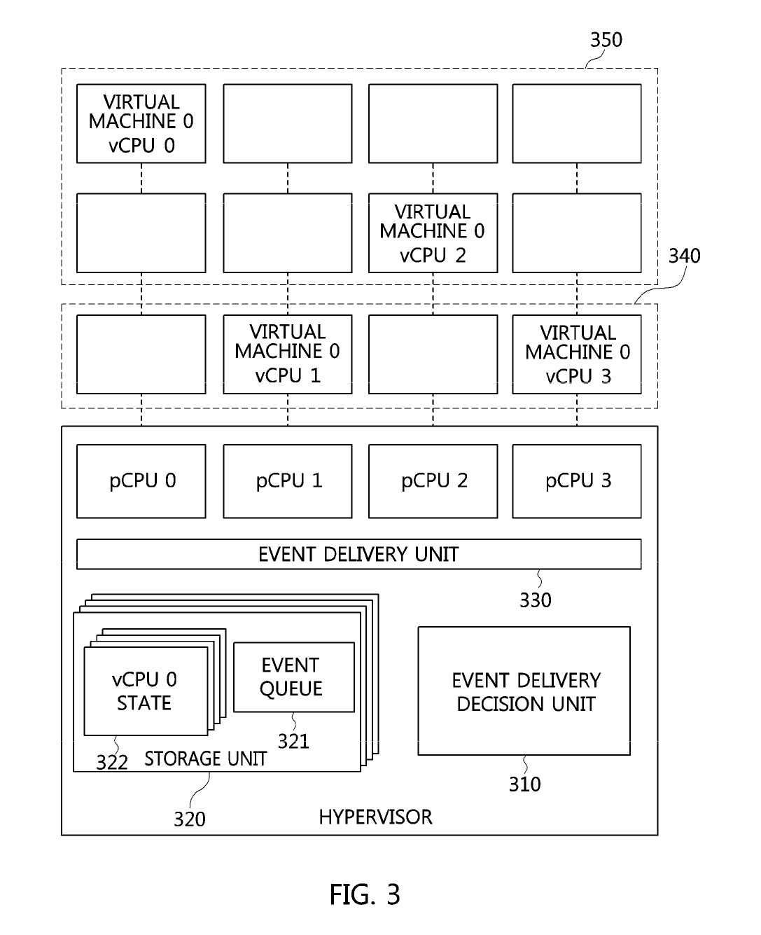

FIG. 2 is a block diagram showing an embodiment of the event delivery unit shown in FIG. 1.

Referring to FIG. 2, the event delivery unit 110 includes a determination unit 210 and a forwarding unit 220.

The determination unit 210 determines the virtual CPU that operates first, based on state information.

Here, the scheduler may decide on the operating sequence of virtual CPUs. For example, when virtual CPUs vCPU 1 to vCPU 4 are present, the scheduler may direct vCPU 2 to operate first.

At this time, the determination unit 210 recognizes that vCPU 2 has started to operate first, and determines that vCPU 2 is the vCPU that operates first.

The forwarding unit 220 forwards an event temporarily stored in the storage unit to the vCPU determined by the determination unit 210.

For example, when the scheduler directs vCPU 2 to operate first in the case where there are virtual CPUs vCPU 1 to vCPU 4, the forwarding unit 220 may forward the event temporarily stored in the storage unit to vCPU 2 immediately after vCPU 2 has operated.

Alternately, the event stored in the storage unit may be forwarded before the virtual CPU is operated. For example, the event may be delivered before vCPU 2 is operated in the case where all of the virtual CPUs vCPU 1 to vCPU 4 are determined to be in a stopped state and the event is temporarily stored in the storage unit, and where the scheduler in the hypervisor designates the virtual CPU that operates first as vCPU 2 and the event temporarily stored in the storage unit must be delivered to vCPU 2. That is, the delay in the event processing by the virtual machine may be minimized by enabling the event to be processed at the same time that vCPU 2 is operated.

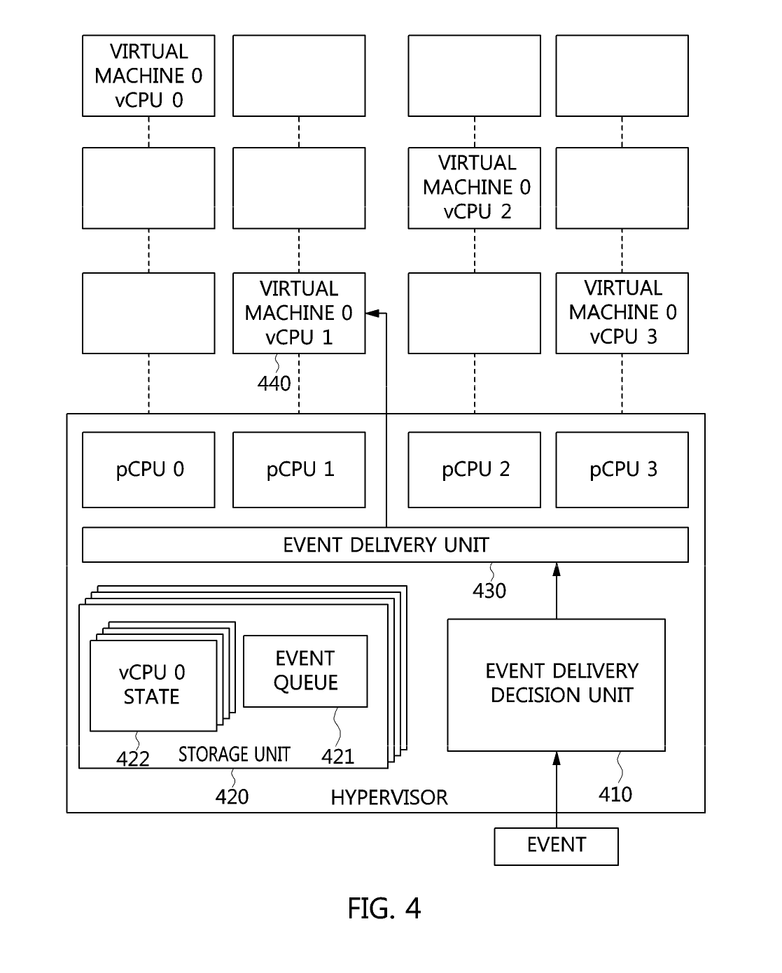

FIG. 3 is a diagram showing a hypervisor in which the event router for an SMP virtual machine using a queue is used according to an embodiment of the present invention.

Referring to FIG. 3, the hypervisor includes an event delivery decision unit 310, storage units 320, an event delivery unit 330, and vCPU queues 340 and 350.

The hypervisor shown in FIG. 3 uses four physical CPUs (pCPUs) and generates four vCPUs.

Here, the vCPU queues 340 and 350 may schedule the vCPUs. This scheduling will be described in detail below. That is, the vCPU queue 340 indicates the state in which an event may be immediately performed using a pCPU. The vCPU queue 350 indicates the state in which an event may be performed after the event has been performed by the vCPU queue 340. That is, the vCPU queues 340 and 350 may perform events in a FIFO manner.

A description is made below using FIG. 3 by way of example. Since vCPU 1 and vCPU 3 of virtual machine 0 are located in the vCPU queue 340, they are in an operating state, in which events can be immediately performed. Since vCPU 2 and vCPU 0 of virtual machine 0 are located in the vCPU queue 350, they are in a stopped state, in which events cannot be immediately performed. That is, when an event is delivered to vCPU 1 and vCPU 3 of virtual machine 0, the event may be immediately processed. In contrast, when an event is delivered to vCPU 0 and vCPU 2 of virtual machine 0, the event cannot be immediately processed, and the processing of the event will be delayed until vCPU 0 and vCPU 2 are located in the vCPU queue 340 and enter an operating state.

Here, virtual machines may be managed in the form of a queue depending on the types of hypervisors and the types of schedulers used by the hypervisors, or in another form.

The number of virtual machines generated by each hypervisor is not limited. In FIG. 3, only a single virtual machine (virtual machine 0) is illustrated, and the operating method thereof is described on the basis thereof. However, the number of virtual machines may be 3, but is not limited thereto.

Each of the storage units 320 may include an event queue 331 and the state information 322 of each virtual CPU (vCPU).

The event queue 321 may temporarily store events when all of virtual CPUs are in a stopped state.

Here, the virtual CPU state information 322 may be transmitted to the event delivery decision unit 310 and may be used to decide on the event delivery method. A detailed description thereof has been made with reference to FIG. 1.

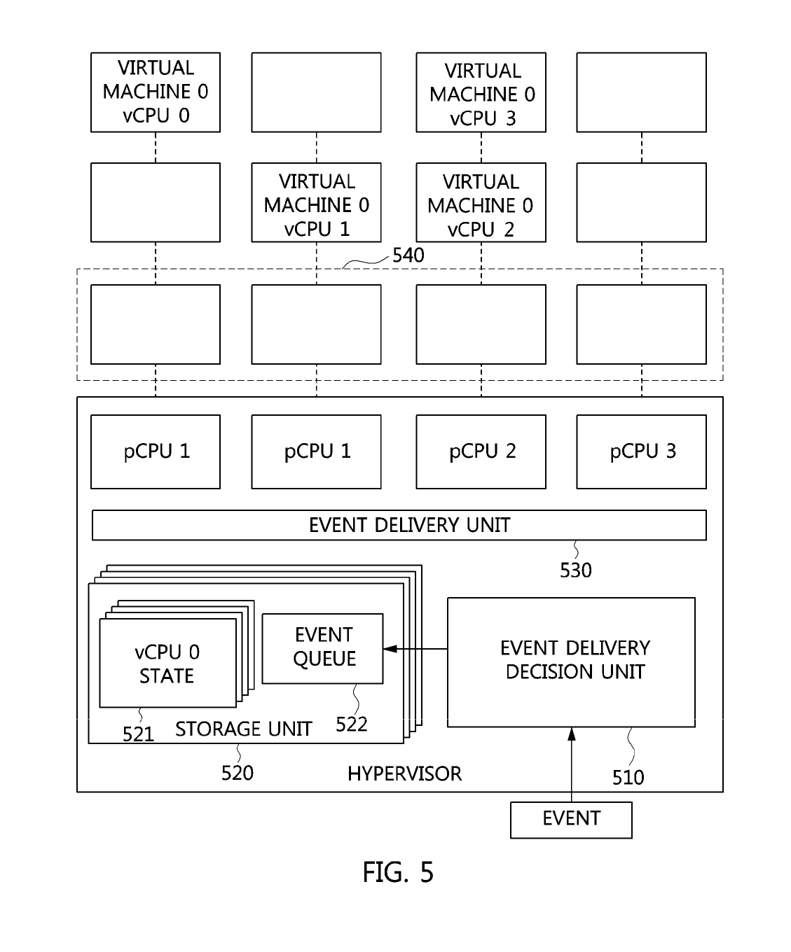

FIG. 4 is a diagram showing event routing when a vCPU in an operating state is present in the event router for an SMP virtual machine using a queue according to an embodiment of the present invention.

Referring to FIGS. 4, a hypervisor includes an event delivery decision unit 410, storage units 420, and an event delivery unit 430.

The event delivery decision unit 410 decides on the event delivery method based on the state information 422 of each vCPU, stored in the corresponding storage unit 420. In FIG. 4, information indicating that vCPU 1 and vCPU 3 are in an operating state is included in the vCPU state information 422. Accordingly, the event delivery decision unit 410 may decide on the method of immediately delivering an event to the corresponding vCPU as the event delivery method.

The event delivery unit 430 delivers the event to the corresponding vCPU depending on the event delivery method decided on by the event delivery decision unit 410. In FIG. 4, the event delivery unit 430 may deliver the event to vCPU 1 using the method of immediately delivering the event to the virtual CPU.

In FIG. 4, although the event is delivered to vCPU 1, it may also be delivered to vCPU 3. In this case, the performances of vCPU 1 and vCPU 3 are compared with each other, and the event is delivered to the vCPU having better performance, thus enabling the time required for event processing to be minimized.

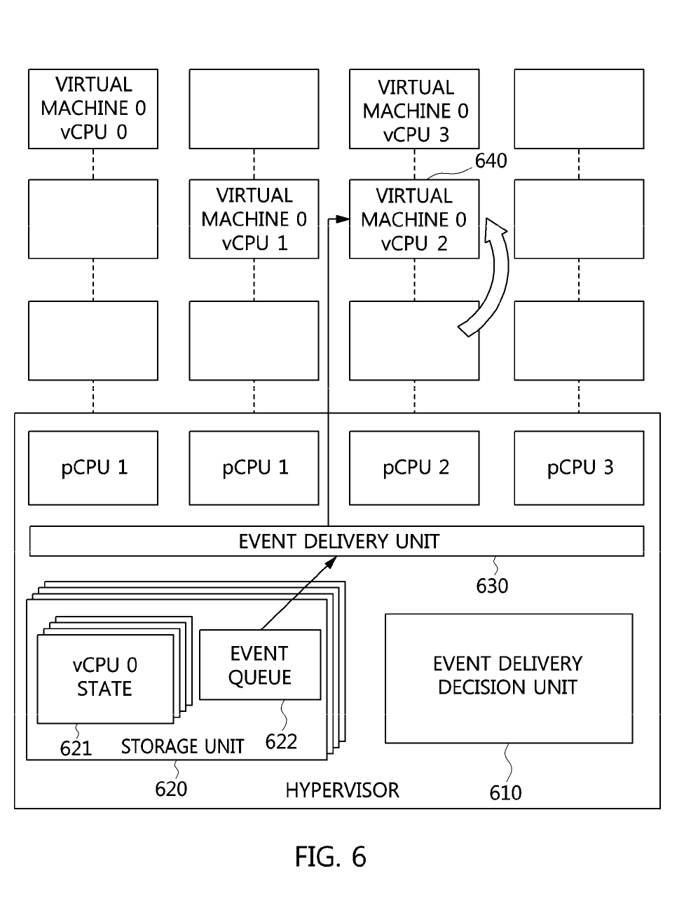

FIGS. 5 and 6 are diagrams showing event routing when no vCPU in an operating state is present in the event router for an SMP virtual machine using a queue according to an embodiment of the present invention.

Referring to FIG. 5, the event router for an SMP virtual machine using a queue includes an event delivery decision unit 510, storage units 520, and an event delivery unit 530.

The event delivery decision unit 510 decides on an event delivery method based on the state information 521 of each vCPU, stored in the corresponding storage unit 520. In FIG. 5, since no vCPU is present in a vCPU queue 540, state information 521 includes information indicating that all of virtual CPUs vCPU 1 to vCPU 4 are in a stopped state. Therefore, the event delivery decision unit 510 may decide on a method of temporarily storing an event in an event queue 522 included in the storage unit 520 without immediately delivering the event to the corresponding virtual CPU, as the event delivery method.

Here, the event queue 522 in the storage unit 520 may receive the event from the event delivery decision unit 510 and temporarily store the event.

In summary, when all vCPUs of the virtual machine that receives the event are in a stopped state, the event is stored in the event queue 522 of the virtual machine that receives the event. For example, if it is assumed that an event to be delivered to virtual machine 0 occurs and all of the vCPUs in virtual machine 0 are in a stopped state, the event is temporarily stored in the event queue 522 of the storage unit 520 assigned to virtual machine 0.

Referring to FIG. 6, the event router for an SMP virtual machine using a queue includes an event delivery decision unit 610, storage units 620, and an event delivery unit 630.

FIGS. 5 and 6 illustrate a succession of processing states.

The event delivery unit 630 determines the virtual CPU that operates first based on state information.

Referring to FIG. 6, the event delivery unit 630 may deliver an event temporarily stored in an event queue 622 to vCPU 2 based on information indicating that the vCPU that operates first is vCPU 2.

Here, the event stored in the event queue 622 may be delivered before the virtual CPU is operated. For example, the event may be delivered before vCPU 2 is operated in the case where all of the virtual CPUs vCPU 1 to vCPU 4 are determined to be in a stopped state and the event is temporarily stored in the corresponding storage unit, and where the scheduler in the hypervisor designates the virtual CPU that operates first as vCPU 2 and the event temporarily stored in the storage unit must be delivered to vCPU 2. That is, the delay in the event processing by the virtual machine may be minimized by enabling the event to be processed at the same time that vCPU 2 is operated.

Here, in methods of delivering events stored in the event queue 622, a FIFO manner may be used. Multiple events may be stored in the event queue 622, and events (older events) which are stored first (first in) may be sequentially delivered to the vCPU (First Out).

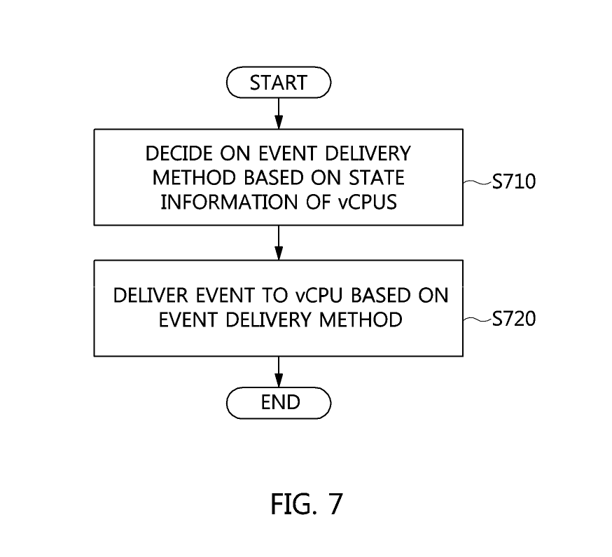

FIG. 7 is an operation flowchart showing an event routing method for an SMP virtual machine using a queue according to an embodiment of the present invention.

First, an event delivery method is decided on based on the state information of vCPUs at step S710.

The state information of the vCPUs may include pieces of information about whether respective virtual CPUs are operating. For example, if it is assumed that there are four vCPUs that are used by the virtual machine, that is, vCPU 1, vCPU 2, vCPU 3, and vCPU 4, information indicating that all of vCPU 1 to vCPU 4 are operating may be the state information of the virtual CPUs.

Here, the methods of delivering events may chiefly include two methods: one is the method of immediately delivering an event to a vCPU and the other is the method of temporarily storing an event without immediately delivering the event to a vCPU and of subsequently delivering the event to the vCPU. When the vCPU is in an operating state, it is faster to immediately deliver the event to the vCPU. However, when an event is immediately delivered to a vCPU that is not in an operating state, the event processing time, together with the time during which the vCPU is waiting for operation, may be lengthened due to the delay time. Therefore, it is preferable to temporarily store the event without immediately delivering the event, determine the vCPU that operates first, and then deliver the event to the determined vCPU, in order to reduce the latency time.

In this case, the step S710 of deciding on the event delivery method may include the step of determining, based on the state information of vCPUs, whether at least one of the virtual CPUs is in an operating state.

Here, at the event delivery method decision step S710, an event delivery method may be decided on, based on the results of determination by the operation/non-operation determination unit. For example, if it is determined that there is any vCPU in an operating state, the event may be immediately transmitted to the event delivery unit 120, and the event delivery unit 120 may deliver the event to the vCPU. In contrast, if it is determined that there is no vCPU in an operating state, the event may be transmitted to a storage unit (not shown) so as to be stored in the storage unit, without being immediately transmitted to the event delivery unit 120.

The storage unit may temporarily store the event in a queue.

The events stored in the storage unit may be delivered to the corresponding vCPUs in a FIFO manner.

The FIFO manner may denote a scheme in which the oldest (first) event is processed first (earlier than the last event).

The event delivery unit 120 delivers the corresponding event to the vCPU based on the event delivery method and the state information.

Further, the event is delivered to the corresponding vCPU based on the event delivery method at step 5720.

When it is determined by the event delivery decision unit 110 that there is any vCPU in an operating state and the event is transmitted to the event delivery unit 120, the event delivery unit 120 may receive the event and deliver it to the vCPU.

Further, when it is determined by the event delivery decision unit 110 that all vCPUs are in a stopped state and the event is transmitted to the storage unit, the event delivery unit 120 may receive the event from the storage unit and deliver it to the corresponding vCPU.

Here, the virtual CPU that operates first is determined based on the operating state information, and the event temporarily stored in the storage unit may be delivered to the virtual CPU that operates first. For example, if it is assumed that all of the virtual CPUs vCPU 1 to vCPU 4 are determined to be in a stopped state and the event is temporarily stored in the storage unit, the scheduler in the hypervisor may designate the virtual CPU that operates first as vCPU 2, and the event temporarily stored in the storage unit may be delivered to vCPU 2.

Here, the event stored in the storage unit may also be delivered to the corresponding vCPU before the vCPU is operated. For example, the event may be delivered before vCPU 2 is operated in the case where all of the virtual CPUs vCPU 1 to vCPU 4 are determined to be in a stopped state and the event is temporarily stored in the storage unit, and where the scheduler in the hypervisor designates the virtual CPU that operates first as vCPU 2 and the event temporarily stored in the storage unit must be delivered to vCPU 2. That is, the delay in the event processing by the virtual machine may be minimized by enabling the event to be processed at the same time that vCPU 2 is operated.

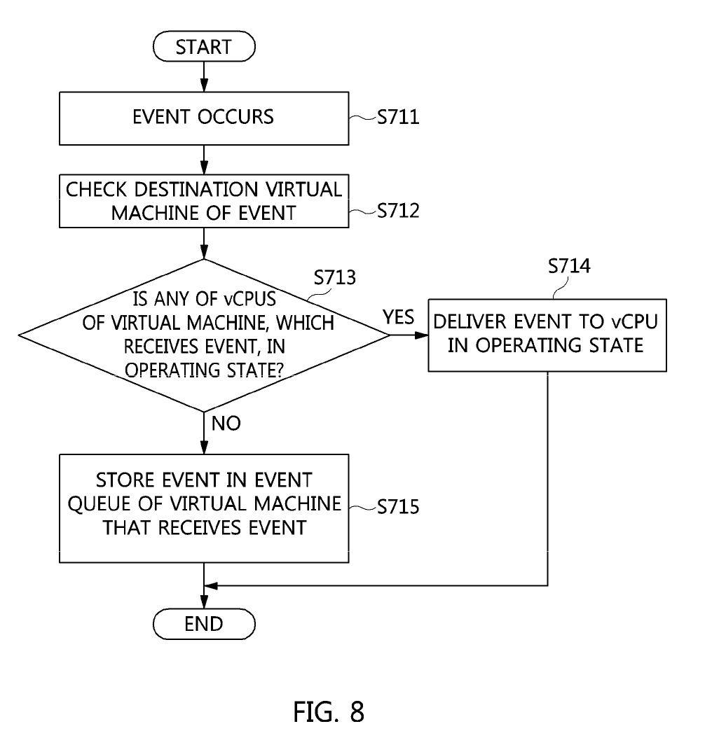

FIG. 8 is an operation flowchart showing in detail the step 5710 of deciding on the event delivery method, shown in FIG. 7.

Referring to FIG. 8, when an event occurs at step S711, the destination virtual machine for the event is checked at step S712.

Then, it is determined whether any of the vCPUs of the virtual machine that receives the event is in an operating state at step S713.

In this regard, whether any of the vCPUs of the virtual machine is in an operating state may be determined based on the state information of the vCPUs, stored in the storage unit.

Here, the state information of the vCPUs may include information about whether each of the vCPUs is in an operating state. For example, when there are four vCPUs used by the virtual machine, that is, vCPU 1, vCPU 2, vCPU 3, and vCPU 4, information indicating that all of the virtual CPUs vCPU 1 to vCPU 4 are in an operating state may be the state information of the virtual CPUs.

Here, if it is determined that any of the vCPUs is in an operating state, the event is delivered to the vCPU that is in an operating state at step S714.

In contrast, if it is determined that there is no vCPU in an operating state, the event is stored in the event queue at step S715. If the event is immediately delivered to the vCPU when the vCPU is not in an operating state, the event processing time, together with the time for which the vCPU is waiting for operation, may be lengthened due to the delay time. Therefore, it is preferable to temporarily store the event without immediately delivering the event, determine the vCPU that operates first, and then deliver the event to the determined vCPU, in order to reduce the latency time.

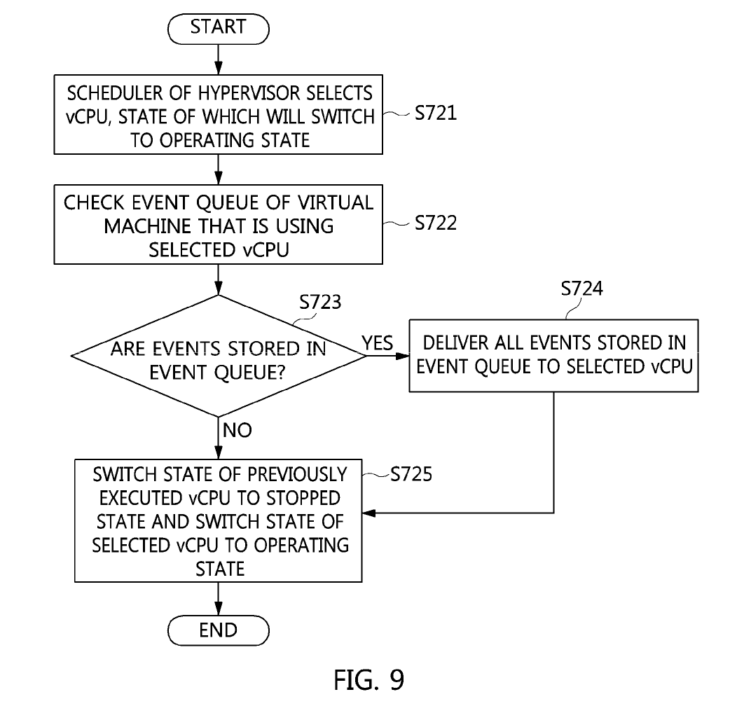

FIG. 9 is an operation flowchart showing in detail the step S720 of delivering an event to a vCPU, shown in FIG. 7.

Referring to FIG. 9, the scheduler of the hypervisor selects a vCPU, the state of which will switch to an operating state, at step S721.

Further, the event queue of a virtual machine that is using the selected vCPU is checked at step S722.

Next, whether any events are stored in the event queue is determined at step S723.

Here, if it is determined that no event is stored in the event queue, the state of the vCPU that has been previously executed switches to a stopped state, and the state of the selected vCPU switches to an operating state at step S725.

If there are any events stored in the event queue, all of the events stored in the event queue are delivered to the selected vCPU at step S724.

The present invention may decide on the event delivery method using operating state information provided by a hypervisor, thus greatly reducing the delay in event processing.

Further, the present invention may remarkably reduce the delay in event processing by delivering an event stored in an event queue to the virtual CPU that operates first.

As described above, in the router and method for routing an event for an SMP virtual machine using a queue according to the present invention, the configurations and schemes in the above-described embodiments are not limitedly applied, and some or all of the above embodiments can be selectively combined and configured so that various modifications are possible.

What is claimed is:

1. An event router for a virtual machine, comprising:
an event delivery decision unit for deciding on a method of delivering an event that is provided to a hypervisor, based on state information of virtual Central Processing Units (vCPUs) used by a Symmetric Multiprocessor (SMP) virtual machine; and
an event delivery unit for delivering the event to a relevant virtual CPU based on both the event delivery method and the state information.

2. The event router of claim 1, wherein the event delivery method includes a method of immediately delivering the event to the relevant virtual CPU and a method of temporarily storing the event in a storage unit.

3. The event router of claim 2, wherein the state information of the virtual CPUs includes information about whether each of the virtual CPUs is in an operating state.

4. The event router of claim 3, wherein the event delivery decision unit comprises an operation/non-operation determination unit for determining, based on the state information, whether at least one of the virtual CPUs is in an operating state.

5. The event router of claim 4, wherein the event delivery decision unit is configured to, when it is determined that there is a virtual CPU in an operating state, transmit the event to the event delivery unit.

6. The event router of claim 4, wherein the event delivery decision unit is configured to, when it is determined that all of the virtual CPUs are in a stopped state, temporarily store the event in the storage unit.

7. The event router of claim 6, wherein the event delivery unit comprises:
a determination unit for determining a virtual CPU that operates first, based on the state information; and
a forwarding unit for forwarding the event temporarily stored in the storage unit to the virtual CPU determined by the determination unit.

8. The event router of claim 7, wherein the forwarding unit forwards the event before the virtual CPU is operated.

9. The event router of claim 8, wherein the storage unit temporarily stores the event in a queue.

10. The event router of claim 9, wherein the forwarding unit forwards the event to the virtual CPU in a First In First Out (FIFO) manner.

11. An event routing method for a virtual machine, comprising:
deciding on a method of delivering an event that is provided to a hypervisor, based on state information of virtual Central Processing Units (vCPUs) used by a Symmetric Multiprocessor (SMP) virtual machine; and
delivering the event to a relevant virtual CPU based on both the event delivery method and the state information.

12. The event routing method of claim 11, wherein the event delivery method includes a method of immediately delivering the event to the relevant virtual CPU and a method of temporarily storing the event in a storage unit.

13. The event routing method of claim 12, wherein the state information of the virtual CPUs includes information about whether each of the virtual CPUs is in an operating state.

14. The event routing method of claim 13, wherein deciding on the event delivery method comprises determining, based on the state information, whether at least one of the virtual CPUs is in an operating state.

15. The event routing method of claim 14, wherein deciding on the event delivery method is configured to, when it is determined that there is a virtual CPU in an operating state, decide on a method of delivering the event to the relevant virtual CPU as the event delivery method.

16. The event routing method of claim 14, wherein deciding on the event delivery method is configured to, when it is determined that all of the virtual CPUs are in a stopped state, decide on a method of temporarily storing the event in the storage unit as the event delivery method.

17. The event routing method of claim 16, wherein delivering the event to the relevant virtual CPU comprises:
determining a virtual CPU that operates first, based on the state information; and
forwarding the event temporarily stored in the storage unit to the virtual CPU that operates first.

18. The event routing method of claim 17, wherein forwarding the event to the virtual CPU is configured to forward the event before the virtual CPU is operated.

19. The event routing method of claim 18, wherein the storage unit temporarily stores the event in a queue.

20. The event routing method of claim 19, wherein forwarding the event to the virtual CPU is configured to forward the event to the virtual CPU in a First In First Out (FIFO) manner.
